(19) United States
(12) Patent Application Publication
(10) Pub. No.: US 2013/0204968 A1
(43) Pub. Date: Aug. 8, 2013

(54) FILE TRANSFER APPARATUS AND FILE TRANSFER SYSTEM

(71) Applicants: KABUSHIKI KAISHA TOSHIBA, Tokyo (JP); TOSHIBA TEC KABUSHIKI KAISHA, Tokyo (JP)

(72) Inventors: Jun Sasano, Tokyo-to (JP); Tomohide Oka, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/749,855

(22) Filed: Jan. 25, 2013

Related U.S. Application Data
(60) Provisional application No. 61/593,948, filed on Feb. 2, 2012.

(51) Int. Cl. H04L 29/08

(52) U.S. Cl. CPC H04L 67/06
USPC 709/217

(57) ABSTRACT

A file transfer apparatus, which is connected with a first NGN (Next Generation Network), sends a sending file to a third file transfer apparatus connected with a second NGN by using a second file transfer apparatus connected with the second NGN as a relay apparatus comprises a file storage unit configured to store the sending file, a sending destination file generation unit configured to generate a sending destination file containing the third file transfer apparatus as the sending destination, a relay information generation unit configured to generate a relay information item specifying the second file transfer apparatus, a hash value calculation unit configured to calculate a hash value according to the sending file, the sending destination file and the relay information item and a sending unit configured to send the sending file, the sending destination file and the hash value to the second file transfer apparatus.

### CROSS-REFERENCE TO RELATED APPLICATIONS

This application is based upon and claims the benefit of priority from U.S. Provisional Application No. 61/593,948 filed on Feb. 2, 2012; the entire contents of which are incorporated herein by reference.

### FIELD

Embodiments described herein relate to a file transfer apparatus and a file transfer system.

### BACKGROUND

In recent years, along with the high-speed broadband drastic popularization of an access network using an ADSL (Asymmetric Digital Subscriber Line), an FTTH (Fiber To The Home) and the like, a technology using an IP (Internet Protocol) network called as VoIP (Voice over IP) to carry out communication was developed.

In such a network, for example, a network which is called as NGN (Next Generation Network) and can also carry out image communication, high-speed data communication and the like besides voice communication is also proposed.

On the other hand, an IETF (Internet Engineer Task Force) limits an SIP (Session Initiation Protocol), and the IETF is a standardization organization of an internet. The SIP is a protocol for impelling standardization as a technology realizing real-time communication (such as the voice over IP, a image conference and the like) on an IP network.

A file transfer apparatus for connecting an information terminal such as a personal computer (PC), an image forming apparatus (MFP: Multi Function Peripheral) and the like with the NGN, so as to receive and send data by utilizing the SIP, was known.

### BRIEF DESCRIPTION OF THE DRAWINGS

FIG. 1 is an exemplary diagram illustrating the configuration of a file transfer system using a file transfer apparatus of a present embodiment;

FIG. 2 is an exemplary block diagram illustrating the configuration of the file transfer apparatus according to the present embodiment;

FIG. 3 is an exemplary flow chart illustrating file sending procedures in the file transfer apparatus according to the present embodiment;

FIG. 4 is an exemplary diagram illustrating a file sending instruction screen in the file transfer apparatus according to the present embodiment;

FIG. 5 is an exemplary diagram illustrating a sending destination file established in the file transfer apparatus according to the present embodiment;

FIG. 6 is an exemplary diagram for describing a method for calculating a hash value in the file transfer apparatus according to the present embodiment;

FIG. 7 is an exemplary flow chart illustrating file relay procedures in the file transfer apparatus according to the present embodiment; and

FIG. 8 is an exemplary flow chart illustrating relay transfer processing procedures in the file transfer apparatus according to an another embodiment.

### DETAILED DESCRIPTION

In accordance with an embodiment, a file transfer apparatus, which is connected with a first NGN (Next Generation Network), sends a sending file to a third file transfer apparatus connected with a second NGN by using a second file transfer apparatus connected with the second NGN as a relay apparatus comprises a file storage unit configured to store the sending file, a sending destination file generation unit configured to generate a sending destination file containing the third file transfer apparatus as the sending destination, a relay information generation unit configured to generate a relay information item specifying the second file transfer apparatus, a hash value calculation unit configured to calculate a hash value according to the sending file, the sending destination file and the relay information item and a sending unit configured to send the sending file, the sending destination file and the hash value to the second file transfer apparatus.

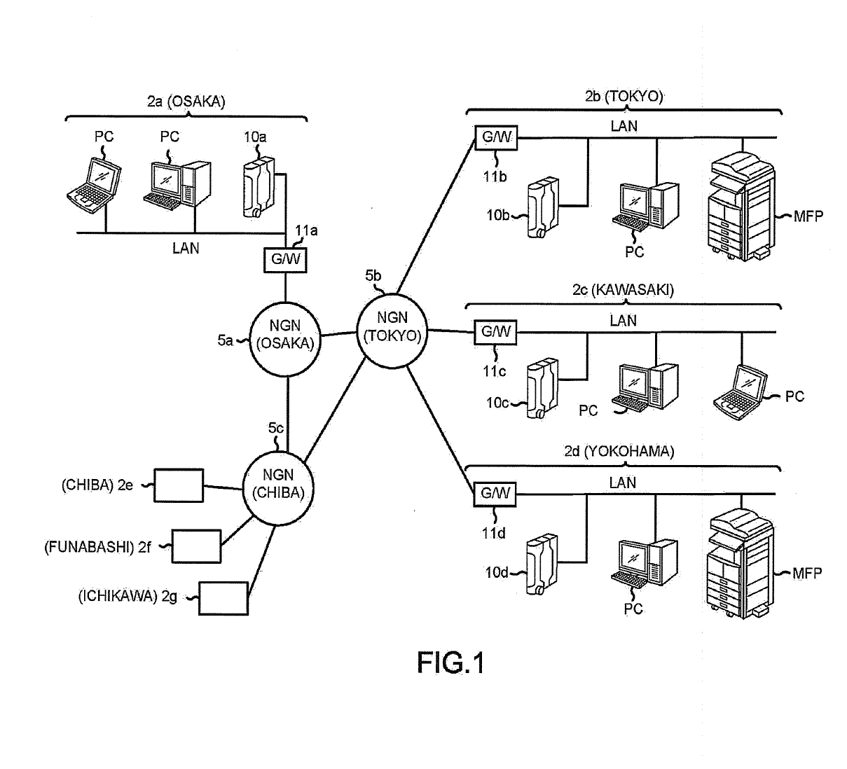

FIG. 1 is an exemplary diagram illustrating the configuration of a file transfer system using the file transfer apparatus of the present embodiment.

The file transfer system 1 comprises a plurality of unit systems 2a, 2b, 2c and 2d and a plurality of communication lines 5a and 5b. Moreover, file transfer apparatuses 10a, 10b, 10c and 10d, gateways (G/W) 11a, 11b, 11c and 11d, and a PC (personal computer), a digital compound machine (MFP: Multi Function Peripheral) and the like, which are subjected to signal connection by an LAN (Local Area Network), are respectively arranged in the unit systems 2a, 2b, 2c and 2d.

A communication line 5 forms an information communication network which is called as NGN, and as described above, can also carry out high-precision image communication and high-speed data communication besides voice communication. The NGN is formed based on an IP technology to be that the unit systems can be also connected by an SIP (Session Initiation Protocol) and can be also connected by an Internet by using an HTTP (Hyper Text Transfer Protocol) (or are connected by using the HTTP (Hyper Text Transfer Protocol) based on the internet)

The gateways 11a, 11b, 11c and 11d are connected with the external communication lines 5a and 5b, and moreover, are connected with the file transfer apparatuses 10a, 10b, 10c and 10d in the unit systems 2a, 2b, 2c and 2d.

The file transfer apparatuses 10a, 10b, 10c and 10d are adapters (interface) for receiving and sending data with the unit systems 2a, 2b, 2c and 2d connected with the external communication lines 5a and 5b through the gateways 11a, 11b, 11c and 11d by utilizing the SIP.

The file transfer apparatuses 10a, 10b, 10c and 10d can send an designed file on the NGN according to an indication from the PC. Moreover, the PC can download a file stored in the file transfer apparatuses 10a, 10b, 10c and 10d. The file transfer apparatuses 10a, 10b, 10c and 10d can send a scanned original on the NGN according to an indication from the digital compound machine. Moreover, the digital compound machine can print the file received by the file transfer apparatuses 10a, 10b, 10c and 10d.

In the file transfer system shown in FIG. 1, the unit system 2a is connected with the communication line 5a administrating the Osaka area. The unit system 2a is arranged in Osaka city. The unit systems 2b, 2c and 2d are connected with the communication line 5b administrating the Tokyo area. The unit system 2b is arranged in the Tokyo metropolitan area. The unit system 2c is arranged in Kawasaki city. The unit system 2d is arranged in Yokohama city.

In addition, the graphical representation or the omission is briefly carried out in FIG. 1, but a communication line 5c is also connected with the communication line 5a and is also connected with unit systems 2e, 2f and 2g. In the unit systems 2e, 2f and 2g, similar to the unit systems described above, file transfer apparatuses 10e, 10f and 10g, gateways (G/W) 11e, 11f and 11g, and the PC, the MFP and the like, which are connected to the signal connection by the LAN, are respectively arranged.

In addition, the attention should be paid to that: in the following descriptions, for simplification, a unit system 2, the communication line 5, a file transfer apparatus 10, a gateway 11 and the like, and a subscript (suffix) marked in the drawings are omitted to be recorded as required.

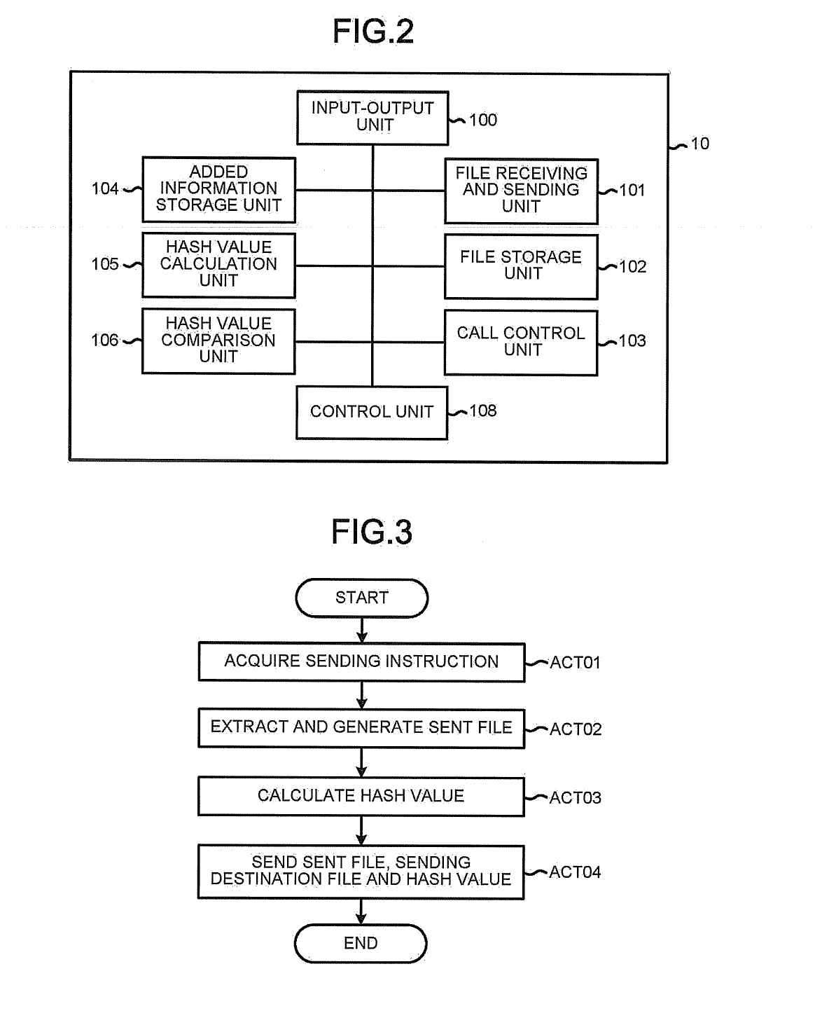

FIG. 2 is an exemplary block diagram illustrating the configuration of the file transfer apparatus of the present embodiment. In addition, the attention should be paid to that the file transfer apparatus 10 as described above has a function of executing file sending and file reception, and therefore, a control block carrying out an action only in a sending process, a control block generating the action only in a reception process and a control block carrying out the action both in the sending process and the reception process are arranged in the file transfer apparatus 10.

The file transfer apparatus 10 comprises an input-output unit 100, a file receiving and sending unit 101, a file storage unit 102, a call control unit 103, an additional information storage unit 104, a hash value calculation unit 105, a hash value comparison unit 106 and a control unit 108.

The input-output unit 100 is an interface executing signal transfer with other unit system 2 through the communication line 5 and also executing a signal transfer action with the PC and the MFP which are connected by an LAN cable in the same unit system 2. The file receiving and sending unit 101 executes the reception and the sending of the file. The file storage unit 102 stores the file in a memory. Herein, an SD card, an HDD and the like can be used as the memory. The call control unit 103 executes a connection action with the transfer destination of the file by the SIP.

The additional information storage unit 104 stores information which is added to the file and subjected to transfer. As the information to be added, the information about a sending destination, the hash value (described in detail below) and the like exist. The hash value calculation unit 105 calculates the hash value according to the file to be transferred, the additional information and the like. The hash value comparison unit 106 judges the existence of the tampering of the file by comparing the hash value.

Next, file transfer actions in the file transfer system are described.

In the following descriptions, the following case is described as a main case: the file to which a relay sending instruction is attached is sent to the file transfer apparatus 10b positioned in Tokyo from the file transfer apparatus 10a positioned in Osaka through the communication line 5a and the communication line 5b, and subsequently, the file is transferred to the file transfer apparatus 10c positioned in Kawasaki and the file transfer apparatus 10d positioned in Yokohama from the file transfer apparatus 10b positioned in Tokyo.

FIG. 3 is an exemplary flow chart illustrating file sending procedures in the file transfer apparatus of the present embodiment. In addition, the attention should be paid to that flows shown in FIG. 3 are action procedures in the file transfer apparatus 10a positioned in Osaka.

A user indicates the sending after using a Web browser (file sending designation screen) of the PC to design a sending file 31 and the sending destination. In ACT 01, the control unit 108 of the file transfer apparatus 10 acquires a file sending instruction sent from the PC.

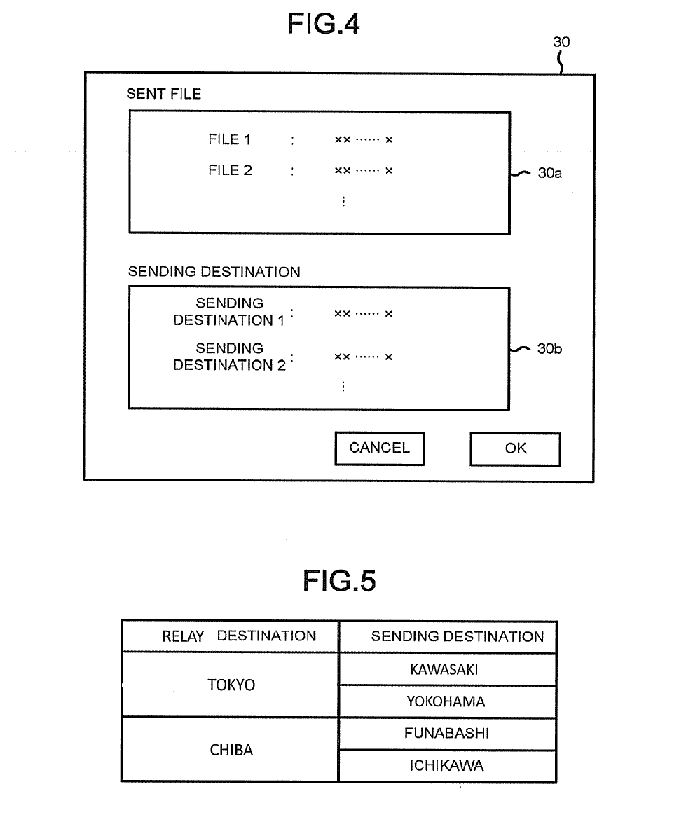

FIG. 4 is an exemplary diagram illustrating a file sending instruction screen in the file transfer apparatus of the present embodiment.

A sending file designation column 30a and a sending destination designation column 30b are arranged on the file sending instruction screen 30. The name of the file to be sent is designed in the sending file designation column 30a. The name (or address) of the sending destination is designed in the sending destination designation column 30b. Moreover, when the user presses down an OK button, the PC extracts the designed sending file 31, and sends a sending instruction to the file transfer apparatus 10a together with the name of the sending destination.

In the file transfer apparatus 10a, the file receiving and sending unit 101 receives the sent data, and the file storage unit 102 stores the sending file in the memory.

In ACT 02, the control unit 108 extracts the sending file 31 and generates the sending destination file 32 according to the name of the sending destination.

FIG. 5 is an exemplary diagram illustrating the sending destination file generated in the file transfer apparatus of the present embodiment.

It is assumed that the sending destinations designed by the user are four cities, that is, the Kawasaki city, the Yokohama city, the Ichikawa city and the Funabashi city. The control unit 108 determines a route for sending the file. That is, the control unit 108 determines that the file transfer apparatus 10b positioned in Tokyo is used as the relay apparatus to send the file to the file transfer apparatus 10c positioned in Kawasaki and the file transfer apparatus 10d positioned in Yokohama. In addition, in order to send the file to the file transfer apparatus 10f positioned in Ichikawa and the file transfer apparatus 10g positioned in Funabashi, the control unit 108 determines that the file transfer apparatus 10e positioned in Chiba is used as the relay apparatus.

In the sending destination file 32 shown in FIG. 5, the telephone numbers of the file transfer apparatus 10c positioned in Kawasaki and the file transfer apparatus 10d positioned in Yokohama are recorded as the sending destinations. In addition, the telephone numbers of the file transfer apparatus 10f positioned in Ichikawa and the file transfer apparatus 10g positioned in Funabashi are recorded as sending destinations.

In ACT 03, the hash value calculation unit 105 calculates the hash value.

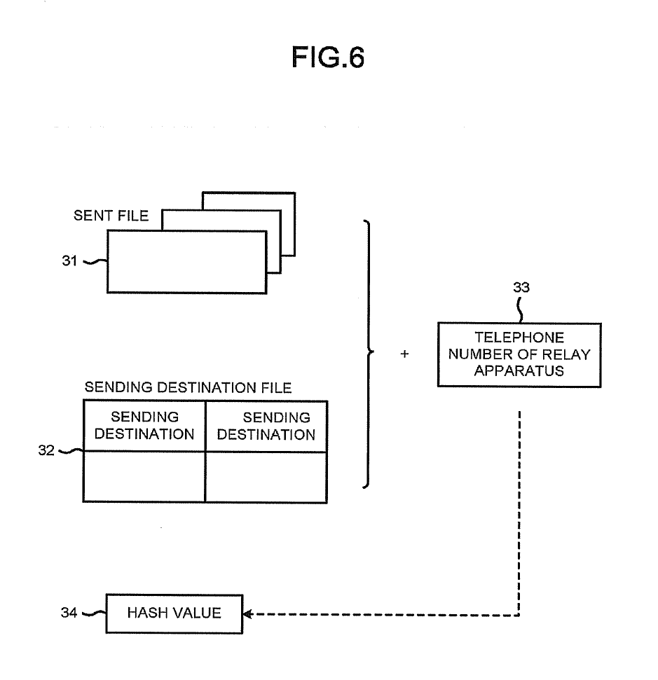

FIG. 6 is an exemplary diagram for describing a method for calculating the hash value in the file transfer apparatus of the present embodiment.

The hash value calculation unit 105 calculates a hash value 34 from the sending file 31, the sending destination file 32 and the telephone number 33 of the relay apparatus (Tokyo)

In ACT 04, the file receiving and sending unit 101 sends the sending file 31, the sending destination file 32 and the hash value 34 together with the transfer command to the file transfer apparatus 10b positioned in Tokyo. In addition, when the sending is carried out, the call control unit 103 sends the “INVITE” of an SIP method to the telephone number 33 of the relay apparatus to establish a session, and the file receiving and sending unit 101 executes the sending after the session is established.

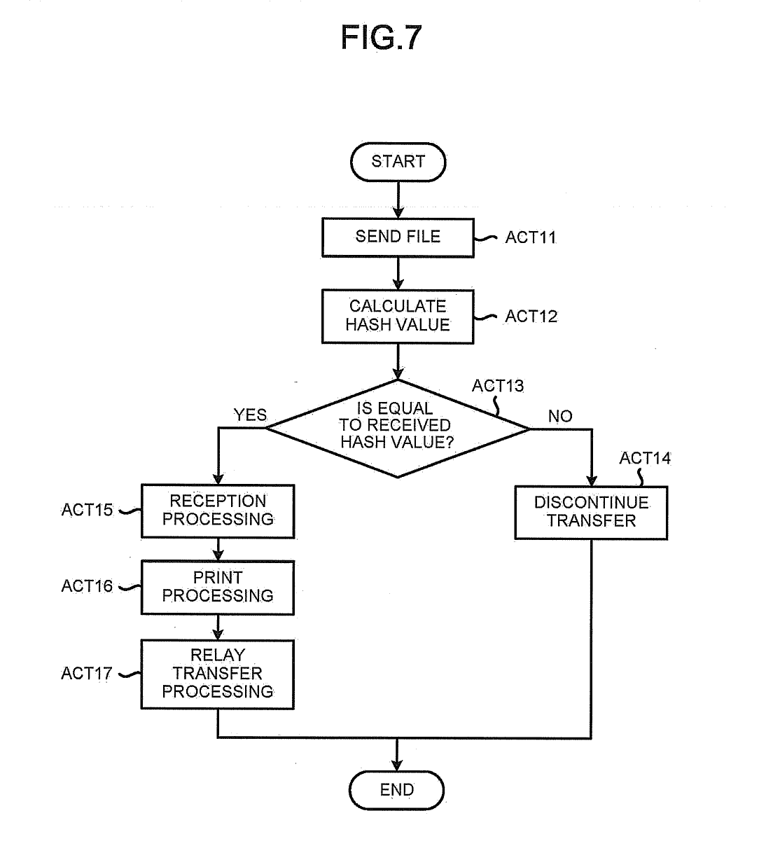

FIG. 7 is an exemplary flow chart illustrating file relay procedures in the file transfer apparatus of the present embodiment. In addition, the attention should be paid to that flows shown in FIG. 7 are action procedures in the file transfer apparatus 10b positioned in Tokyo.

In ACT 11, the file receiving and sending unit 101 receives the transfer command and the sent data (file, hash value). The file storage unit 102 stores the sending file 31 in the memory, and the additional information storage unit 104 stores the sending destination file 32 and the hash value 34 in the memory. In ACT 12, the hash value calculation unit 105 calculates a hash value 35 for confirming from the sending file 31, the sending destination file 32 and the telephone number of its own self (relay apparatus 10b)

In ACT 13, the hash value comparison unit 106 investigates whether or not the received hash value 34 is consistent with the hash value 35 for confirming. In the condition that the received hash value 34 is inconsistent with the hash value 35 for confirming (in ACT 13, NO), for example, it is thought that the sending file 31 and the sending destination file 32 is falsified or sent to an incorrect transfer apparatus. Therefore, in ACT 14, the control unit 108 discontinues the subsequent transfer and executes the specified processing. For example, the message of a content that the transfer has been discontinued is sent to the file transfer apparatus 10a positioned in Osaka serving as a sending source to end the processing.

In the condition that the received hash value 34 is consistent with the hash value 35 for confirming (in ACT 13, YES), the control unit 108 executes reception processing in ACT 15. If its own self (relay apparatus 10b) is contained therein (in the sending destination file 32) as the sending destination in the sending destination file 32, the file storage unit 102 stores the received file in the memory. In ACT 16, the control unit 108 executes print processing. For example, the MFP is enabled to print a log denoting that the transfer command is received from the file transfer apparatus 10a. Moreover, If its own self (relay apparatus 10b) is contained therein (in the sending destination file 32) as the sending destination in the sending destination file 32, the control unit 108 enables the MFP to print the received sending file 31. In ACT 17, the control unit 108 executes relay transfer processing.

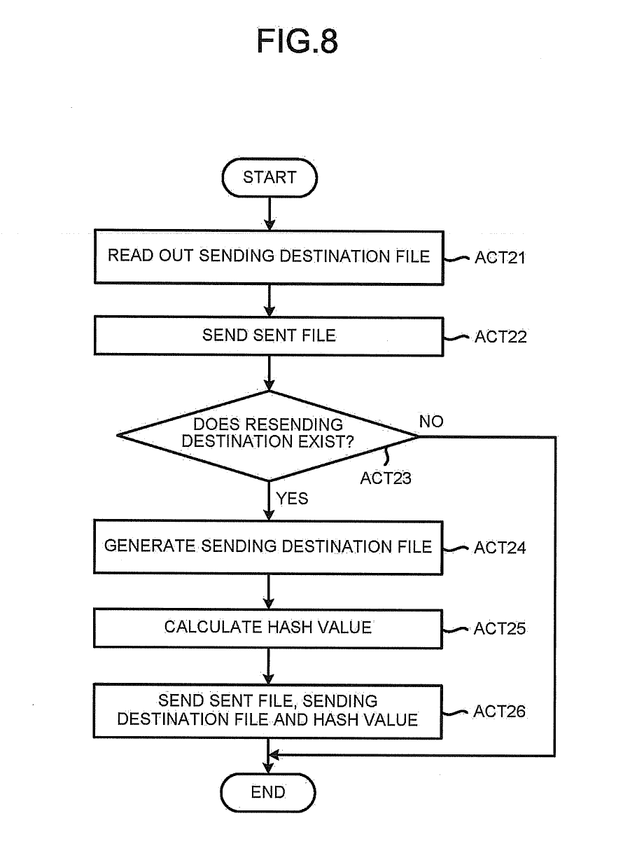

FIG. 8 is an another exemplary flow chart illustrating relay transfer processing procedures in the file transfer apparatus of the present embodiment.

Here, in case that the sending destinations designed by the user are four cities, the Kawasaki city, the Yokohama city, the Ichikawa city and the Funabashi city, the file transfer apparatus 10b positioned in Tokyo determines a route for sending the file. That is, the file transfer apparatus 10b determines that the file transfer apparatus 10e positioned in Chiba is used as the relay apparatus to send the file to the file transfer apparatus 10f positioned in Ichikawa and the file transfer apparatus 10g positioned in Funabashi. In such a case, the telephone numbers of the file transfer apparatus 10f positioned in Ichikawa and the file transfer apparatus 10 g positioned in Funabashi are recorded as resending destinations in the sending destination file 32 shown in FIG. 5. In addition, the telephone number of the file transfer apparatus 10b serving as the initial relay apparatus and positioned in Tokyo is not recorded in the sending destination file 32.

In ACT 21, the control unit 108 reads out the sending destination file 32. In ACT 22, the file receiving and sending unit 101 carries out the sending of the sending file 31 towards the sending destination recorded in the sending destination file 32 (sends the sending file 31 to the sending destination recorded in the sending destination file 32). In addition, in the condition that its own self (relay apparatus 10b) has been recorded in the sending destination, the sending of the sending file 31 (sending the sending file 31) is carried out towards the relay apparatus 10 except its own self. In such a condition, the sending of the sending file 31 (sending the sending file 31 only) is only carried out without calculating the hash value. In ACT 23, whether or not the resending destination is recorded in the sending destination file 32 is investigated. In the condition that the resending destination is not recorded in the sending destination file 32 (in ACT 23, NO), the processing is ended.

In the condition that the resending destination is recorded in the sending destination file 32 (in ACT 23, YES), the control unit 108 generates a new sending destination file 32 in ACT 24.

That is, a new sending destination and a new resending destination are set from the resending destination. In the present embodiment, the telephone number of the file transfer apparatus 10f positioned in Ichikawa and the telephone number of the file transfer apparatus 10g positioned in Funabashi are recorded as the new sending destinations, and the new resending destination is set to be blank. Afterwards, the telephone number of the file transfer apparatus 10e serving as the relay apparatus and positioned in Chiba is set as the telephone number 33 of a new relay apparatus.

In ACT 25, the hash value calculation unit 105 calculates the hash value. The hash value calculation unit 105 calculates the hash value 34 from the sending file 31, the sending destination file 32 and the telephone number 33 of the relay apparatus.

In ACT 26, the file receiving and sending unit 101 sends the sending file 31, the sending destination file 32 and the hash value 34 together with the transfer command to the file transfer apparatus 10e positioned in Chiba. In addition, when the file is sent, the call control unit 103 sends the “INVITE” of the SIP method to the telephone number 33 of the relay apparatus to establish the session, and the file receiving and sending unit 101 executes the sending after the session is established.

In addition, in the above embodiment, the telephone number of the relay apparatus is used in the calculation of the hash value, and this is because that a transfer action using the SIP is taken for example. As described above, in the NGN, the unit systems are not limited to be connected by the SIP (Session Initiation Protocol), and can be also connected by the internet by using the HTTP (Hyper Text Transfer Protocol) (or are connected by using the HTTP (Hyper Text Transfer Protocol) based on the internet). Therefore, the information which can design its own self relay apparatus can be also used, and the telephone number in the present embodiment is not used. For example, as the information specifying the relay apparatus, the telephone number can be also used among the unit systems utilizing the

SIP, and a URL (Uniform Resource Locator) can be also used among the unit systems utilizing the HTTP.

In addition, it can be realized to be that the actions of the file transfer apparatus described in the above embodiment are controlled by the control unit 108.

In addition, each function described in the above embodiment can be also constituted by using hardware, and moreover, can be also realized by reading a program recording each function in a computer by using software. Moreover, each function can be also constituted by selecting any one of the proper software and hardware.

In addition, each function can be also realized by reading the program stored in a recording medium which is not shown in figures in the computer. Herein, so long as the recording medium in the present embodiment is a recording medium which can record the program and is further readable for the computer, the recording form of the recording medium can be in any manners.

In addition, the invention is not limited to keep the above embodiment, and components can be changed and embodied without departing from the spirit of the invention in an implementation stage.

Various inventions can be formed by the proper combinations of a plurality of components disclosed in the above embodiment. For example, some components can be canceled from all the components shown in the embodiment. In addition, the components in different embodiments can be also properly combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A file transfer apparatus, which is connected with a first NGN (Next Generation Network), sends a sending file to a third file transfer apparatus connected with a second NGN by using a second file transfer apparatus connected with the second NGN as a relay apparatus, comprising:
a file storage unit configured to store the sending file;
a sending destination file generation unit configured to generate a sending destination file containing the third file transfer apparatus as the sending destination;
a relay information generation unit configured to generate a relay information item specifying the second file transfer apparatus;
a hash value calculation unit configured to calculate a hash value according to the sending file, the sending destination file and the relay information item; and
a sending unit configured to send the sending file, the sending destination file and the hash value to the second file transfer apparatus.

2. The file transfer apparatus according to claim 1, wherein
the file transfer apparatus communicates by using the second file transfer apparatus and an SIP (Session Initiation Protocol); and
the relay information item is the telephone number of the second file transfer apparatus.

3. A file transfer apparatus, which is connected with a second NGN (Next Generation Network), transfers a sending file received from a first file transfer apparatus connected with a first NGN to a third file transfer apparatus connected with the second NGN, comprising:
a receiving unit configured to receive the sending file, a sending destination file containing the third file transfer apparatus as a sending destination and a first hash value from the first file transfer apparatus;
an additional information storage unit configured to store a relay information item specifying the file transfer apparatus;
a hash value calculation unit configured to calculate a second hash value according to the sending file, the sending destination file and the relay information item; and
a sending unit configured to send the sending file to the third file transfer apparatus in a condition that the first hash value is consistent with the second hash value.

4. The file transfer apparatus according to claim 3, wherein
the sending unit does not send the sending file to the third file transfer apparatus in a condition that the first hash value is inconsistent with the second hash value.

5. The file transfer apparatus according to claim 4, wherein
the file transfer apparatus sends the sending file to a fourth file transfer apparatus by using other file transfer apparatus connected with the third NGN as a relay apparatus when the fourth file transfer apparatus connected with a third NGN is contained in the sending destination file.

6. The file transfer apparatus according to claim 4, wherein
the file transfer apparatus communicates by using the first file transfer apparatus and an SIP (Session Initiation Protocol); and
the relay information item is the telephone number of the file transfer apparatus.

7. A file transfer system, including a first file transfer apparatus connected with a first NGN (Next Generation Network), and a second file transfer apparatus and a third file transfer apparatus which are connected with a second NGN, sends a sending file from the first file transfer apparatus to the third file transfer apparatus via the second file transfer apparatus as a relay apparatus, comprising:
a file storage unit configured to store the sending file;
a sending destination file generation unit configured to generate a sending destination file containing the third file transfer apparatus as a sending destination;
a relay information generation unit configured to generate a first relay information item specifying the second file transfer apparatus;
a hash value calculation unit configured to calculate a first hash value according to the sending file, the sending destination file and the first relay information item; and
a sending unit configured to send the sending file, the sending destination file and the first hash value to the second file transfer apparatus, wherein
the second file transfer apparatus includes:
a receiving unit configured to receive the sending file, the sending destination file and the first hash value from the first file transfer apparatus;
an additional information storage unit configured to store a second relay information item specifying the second file transfer apparatus;
a second hash value calculation unit configured to calculate a second hash value according to the sending file, the sending destination file and the second relay information item; and
a sending unit configured to send the sending file to the third file transfer apparatus in a condition that the first hash value is consistent with the second hash value.

8. The file transfer system according to claim 7, wherein
the sending unit of the second file transfer apparatus does not send the sending file to the third file transfer apparatus in a condition that the first hash value is inconsistent with the second hash value.

9. The file transfer system according to claim 8, wherein
the second file transfer apparatus sends the sending file to a fourth file transfer apparatus by using other file transfer apparatus connected with the third NGN as a relay apparatus when the fourth file transfer apparatus connected with a third NGN is contained in the sending destination file.

10. The file transfer system according to claim 8, wherein
the first transfer apparatus and the second file transfer apparatus communicate by using an SIP (Session Initiation Protocol) each other; and
the first relay information item is the telephone number of the second file transfer apparatus.
